(19) United States
(12) Patent Application Publication
(10) Pub. No.: US 2005/0224639 A1
(43) Pub. Date: Oct. 13, 2005

(54) Venting for thermal aircraft

(75) Inventor: Phillip Robert Kavanagh, Mount Kuring-Gai (AU)

Correspondence Address: FOGG AND ASSOCIATES, LLC, P.O. BOX 581339, MINNEAPOLIS, MN, 55458-1339, US

(73) Assignee: KAVANAGH BALLOONS PTY LIMITED, Mount Kuring-Gai (AU)

(21) Appl. No.: 10/798,842

(22) Filed: Mar. 11, 2004

(51) Int. Cl. B64B 1/40

(52) U.S. Cl. 244/31

(57) ABSTRACT

A thermal aircraft, such as a hot air load-carrying balloon which includes a balloon envelope having a deflation aperture therein, a spider extending across the aperture, and a venting valve or operculum designed to removably cover and seal the aperture and to be opened and/or closed rapidly so as to assist in the control of the balloon, forming both a deflation panel and a manoeuvring port for the balloon. A plurality of limiting lines is provided to extend between the venting valve and the spider or the upper part of the envelope, to suspend the venting valve below the aperture when the valve is in its deflation position. The venting valve is removably and releasably secured to the balloon envelope adjacent the periphery of the aperture, and means are provided for controllably and selectively positioning the valve in the aperture for closed, venting and deflating dispositions thereof. Controls are provided firstly to extend the valve to its maximum surface area, at which point it removably covers and seals the aperture, to allow controlled venting of hot air therefrom, and to allow reefing of the valve from the aperture for rapid deflation of the envelope. This provides the pilot with a great deal of control over the flight of the balloon, especially during final landing procedures and especially during such procedures in gusty or windy conditions, contributing significantly to control and safety.

### BACKGROUND TO THE PRESENT INVENTION

1. Field of the Invention

The present invention relates to venting and deflating arrangements for thermal aircraft, and is particularly concerned with a venting and deflation system for hot air balloons.

2. Description of the Prior Art

Thermal aircraft, such as hot air balloons, comprise an aerostat or an envelope having a top opening with a top cap for closing the opening, and a gondola or basket suspended from the bottom of the envelope. During normal flight, the top opening is closed, but can be partially opened during flight for venting of hot air from the envelope for vertical manoeuvring. After landing at the end of the flight, the top opening is fully opened to deflate the envelope rapidly.

Deflation of the envelope is an important factor in the control of the balloon or other thermal aircraft. It is necessary and desirable, when the balloon has landed, to rapidly deflate the balloon so that the envelope will collapse and prevent the balloon from being blown across the ground by the wind, which has been the cause of many serious ballooning accidents. In the past, rapid deflation has usually been achieved by means of one or more removable panels attached to the envelope by means of hook and loop fasteners such as “Velcro” (Registered Trade Mark) or similar fastening means, or by means of a “parachute valve” temporarily closing and being removable from an aperture at the upper end of the balloon envelope.

The invention of the parachute vent or parachute valve for conventional parachutes is generally attributed to Rohulick, U.S. Pat. No. 2,404,659 published in 1946. Rohulick conceived the idea of a parachute wherein the main parachute canopy or umbrella includes a relatively small auxiliary umbrella to control the opening of an aperture at the top of the main parachute canopy. This concept was subsequently adapted to the control of hot air balloons by Robert Noirclerc (French Pat. No. 2 253 654—see below) in 1973, and by Tracy Barnes in 1974 (not patented). See also U.S. Pat. No. 4,033,527 to Roger Parsons, published in 1976, wherein the adaptation of a parachute valve to hot-air airships is disclosed.

A parachute vent is typically an oversize circular panel manufactured from the same material as that used in the balloon envelope (e.g. high tenacity polyurethane coated ripstop nylon), held in place against the underside of the aperture in the top of the balloon by internal (hot) air pressure. The parachute is prevented from being pushed upwards through the opening by a spider consisting of a central crown ring positioned in the opening and supported by radially extending load tapes. The load tapes are flexible tension elements, and may be formed from webbing, or may be cords or ropes. Irrespective of the material from which they are made, they are referred to as “load tapes” hereinafter. The seal is a suction seal of fabric of the parachute against the fabric of the balloon envelope surrounding the perimeter of the aperture. In effect, the parachute acts as an operculum, and the parachute and associated aperture operate or act as an opercular or operculate valve.

The parachute normally seals and is seated against the balloon aperture, being conventionally centred against the aperture by means of a plurality of centralising lines extending outwardly from the outer perimeter of the parachute and secured to the inner walls of the envelope. A plurality of shroud lines depend downwardly from the perimeter of the parachute, joined together at a point centrally below the parachute, fitted with a pulley. A venting cord passes through this pulley, tethered at one end to the inner wall or a seamed rib of the envelope towards the lower end thereof, with the other end of the venting cord extending to the operator, or balloon pilot, in the gondola or basket below the balloon envelope. In operation, if the pilot wishes to descend or to simply vent the balloon, the pilot pulls the activation cord downwardly, which pulls the perimeter of the parachute downwardly and away from the aperture, breaking the seal and venting the balloon envelope to the atmosphere. As the pilot releases the downward pull pressure on the activation cord, the parachute is forced upwards by the internal pressure within the balloon such that the parachute seats against and seals the upper aperture of the balloon.

As the size of the hot air balloons have increased during recent years, the operation of parachute vents have become a problem for all but very heavy pilots. This problem is exacerbated during the balloon landing phase, since the force required to activate or to open the vent is increased during the landing phase, due to pressure from the escaping air which tends to force the parachute back up against the aperture.

During the past two decades, numerous attempts have been made to improve the reliability of parachute-type vents or to improve the mechanical advantage in operating same. French Pat. No. 2 253 654 (Noirclerc), published in July 1975 and based on an application filed in France in December 1973, discloses a parachute vent for aerostats—including hot air balloons—wherein the vent is a double vent arrangement comprising a small inner parachute vent coaxially and concentrically aligned within a larger outer parachute vent, which in turn controls the closure of an aperture at the upper end of the envelope of a hot air balloon. The small vent is opened first, followed by the opening of the larger vent for precise and rapid deflation of the envelope.

U.S. Pat. No. 4,651,956 to James Winker et al, granted March 1987, discloses a hot air balloon having a top cap or closure valve which forms both a deflation panel and a manoeuvring port for the balloon. The top cap is releasably secured to the balloon envelope by means of a closure assembly including a fixed member secured to the envelope interior and a releasable member which is firstly secured to the top cap and secondly releasably secured to the fixed member. However, once released it is not possible to re-set the top cap in flight, or to terminate or reverse the deflation process once it has been commenced.

U.S. Pat. No. 4,836,471 to Donald Piccard, granted June 1989, discloses a parachute-type vent for hot air balloons which may be opened by applying force to a pull cord having a series of pulleys whereby the applied force is provided with an improved mechanical advantage. In one embodiment, the closure valve is provided with a reefing line to choke the closure valve radially inwardly to open the balloon aperture for rapid deflation of the balloon. However, again it is not possible to reset the valve in flight or to reverse or terminate the deflation process once it has been commenced.

British patent publication No. GB 2260956A in the name of Cameron Balloons Limited (inventor Donald A. Cameron), published in May 1993, discloses a venting valve for a hot air balloon having a parachute panel which may be secured to the envelope by a releasable locking mechanism to limit the valve-opening movement of the parachute panel. In this venting valve, with the parachute panel secured to the envelope by the locking mechanism, the parachute panel is prevented from moving clear of the balloon aperture. This is suitable for in-flight venting of the balloon envelope since the valve can be readily opened and closed in flight. For rapid deflation of the balloon envelope, the locking mechanism is released and the parachute panel moves to a position well clear of the balloon aperture allowing increased outflow of air. However, when the locking mechanism has been released, it is not possible to reset the parachute panel in place during flight.

Also within the last few years another attempt has been made to improve the parachute vent, by the development of the so-called ‘SuperChute’ in the United Kingdom by Lindstrand Balloons Limited (designed by Per Lindstrand and Simon Forse—Patent No: GB2281890, published March 1995). As in the case of a conventional parachute vent, the SuperChute comprises a circular panel which seals against the balloon aperture. It may also have shroud lines from its perimeter joined centrally below the circular panel such that it can be operated like a conventional parachute vent. However, it also comprises a control rope attached to the axial centre of the circular panel of the SuperChute (or to a plurality of ropes which extend radially from the centre of the circular panel to the outer perimeter thereof). The SuperChute is also characterised by the rerouting of the parachute valve centring lines back up to the crown of the balloon envelope where they are held in place by an armed release mechanism or locking device which must be “fired” before actuating the rapid deflation mode. Before activation the SuperChute behaves as a typical pulley-assisted parachute valve either for in-flight venting or for final deflation in moderate wind speeds.

The SuperChute is operated by two lines, one is the arming line and the other is the final deflation line. Until the arming line is pulled, the SuperChute cannot be activated. Once armed the system is ready to activate, but it still allows the pilot to operate it similar to a conventional parachute valve. When the pilot wishes to rapidly descend or to deflate the balloon, he pulls downwardly on the central control rope which causes the parachute valve canopy to gather radially inwardly and downwardly into the balloon centre, in effect forming a plume or to ‘roman candle’ the parachute. The overall effect is to rapidly open the balloon aperture to vent the hot air in the envelope to the atmosphere, causing the balloon to descend and to rapidly deflate. The SuperChute requires much less physical pressure or exertion to operate than does a conventional parachute vent, but it has a disadvantage in that it is not possible to reverse or to reset the SuperChute valve during flight once it has been activated, since resetting is normally carried out from outside the balloon envelope after landing procedures or before embarking on a new flight.

In the present applicant's U.S. Pat. No. 5,584,449, there is disclosed a balloon venting system wherein a parachute valve removably seals a venting aperture of a balloon envelope, and control means are operable to centre the valve relative to the aperture in its closed position and to draw the edge of the valve away from the envelope for venting in flight, and a centre-pull deflation control is provided to reef the valve radially toward the centre of the aperture for deflation of the balloon. The deflation control includes so-called “top strings” which are attached at one end to the centre of the upper surface of the parachute, extend through guides on the crown ring, and attach at their other ends to the edge of the parachute. The top strings support the parachute valve adjacent to the aperture in its deflation position, and this may hamper the egress of air and thus slow down the deflation.

In the present applicant's International application WO 01/26963, there is disclosed a balloon venting system wherein a parachute valve removably seals a venting aperture of a balloon envelope, and control means are operable to centre the valve relative to the aperture in its closed position and to draw the edge of the valve away from the envelope for venting in flight, and a centre-pull deflation control is provided to reef the valve radially toward the centre of the aperture for deflation of the balloon. The deflation control may include so-called centring cords which are attached at one end to the crown ring, and at their other ends to the edge of the parachute. The centring cords are thus approximately equal in length to the radius of the parachute valve, and result in the parachute valve being positioned this distance below the aperture in its deflation position. Resetting of the valve may be difficult from a deflation position far below the aperture, which will result when the parachute is of large diameter.

It is an object of this invention to provide improved venting means for the generation and control of thermal aircraft such as inflatable balloons, and especially hot air balloons.

It is another object of this invention to provide improved venting means for thermal aircraft which go at least some way towards overcoming or at least minimising the prior art problems or limitations outlined above.

It is a further object of this invention to provide improved venting means for thermal aircraft which is universally adaptable for use with any type of thermal aircraft which requires venting of an internal chamber or envelope to the atmosphere.

It is yet another object of this invention to provide improved venting means for thermal aircraft which is relatively simple and inexpensive to manufacture, and which is simple in operation.

It is yet a further object of this invention to provide thermal aircraft which comprise venting means of the type disclosed herein.

Other and further objects of the present invention will become apparent to those skilled in the art upon a study of the following description, appended claims and accompanying drawings.

### SUMMARY OF THE INVENTION

According to one aspect of the present invention there is provided a thermal aircraft, such as a hot air balloon having an outer envelope for containing a quantity of hot air and supporting a load-carrying basket, the envelope having an aperture formed therein at or near its upper end to permit outflow of air from the interior of the envelope, a spider comprising a plurality of load tapes, ropes or cords extending radially across said aperture, removable venting means comprising a parachute panel adapted to close said aperture under pressure of air inside the envelope, first control means operable to move the periphery of the parachute panel away from the aperture to permit controlled venting in flight, and second control means operable to draw the parachute panel radially inwardly and downwardly away from the aperture for rapid deflation of the envelope, and wherein the venting means further includes limiting lines attached at one end to the parachute panel and at their other end to the spider for limiting the downward movement of the parachute panel away from the aperture.

In embodiments of the invention, the parachute panel may occupy a first, closed, position in which the panel removably covers and seals the aperture, a second, venting, position where the outer perimeter of the panel is pulled downwardly away from the perimeter edge of the aperture to variably open same, and a third, deflation, position wherein the panel is contracted radially toward the centre of the aperture and moved downwardly away from the aperture. In the third position, the limiting lines suspend the parachute panel at a predetermined distance beneath the aperture for rapid deflation of the envelope. The lengths of the limiting lines are preferably substantially less than the radius of the parachute vent.

The spider may comprise a central crown ring to which the load tapes are attached, and the limiting lines may be attached at one of their respective ends to the load tapes preferably by sliding attachments such as rings or pulleys loosely encircling the load tapes, and may be attached at their other ends to the parachute panel at or near its periphery, so as to extend radially outwardly of the aperture when the panel is in the closed position. In a particular embodiment of this alternative, limiting means may be provided to limit the radial outward movement of the sliding attachments along the load tapes. The limiting means may be in the form of cords attached to extend between the crown ring and the sliding attachments, or may be in the form of abutments fixed to the load tapes and past which the sliding attachments cannot travel.

In a particular embodiment, the first control means is operable in one mode to move the periphery of the parachute panel away from the aperture to permit controlled venting in flight, and in a second mode to extend the parachute panel laterally or radially to its maximum surface area to removably cover and seal said aperture.

The second control means for contracting the parachute panel may include a control element operatively connected to the central region of the parachute panel for reefing the operculum radially inwardly and axially downwardly away from the aperture. The second control means may comprise a single control line attached to the centre of the underside of the parachute panel, or may comprise a plurality of control lines one end of each of which is attached to the underside of the parachute panel at a position spaced from the centre of the panel. The second control means extends downwardly to a free gripping end accessible to the balloon pilot.

According to another aspect of the present invention there is provided a thermal aircraft, such as a hot air balloon having an outer envelope for containing a quantity of hot air and supporting a load-carrying basket, the envelope having an aperture formed therein at or near its upper end to permit outflow of air from the interior of the envelope, a spider comprising a plurality of load tapes extending radially across said aperture, removable venting means comprising a parachute panel adapted to close said aperture under pressure of air inside the envelope, first control means operable to move the periphery of the parachute panel away from the aperture to permit controlled venting in flight, and second control means operable to draw the parachute panel radially inwardly and downwardly away from the aperture for rapid deflation of the envelope, and wherein the venting means further includes centring lines for limiting the downward movement of the parachute panel away from the aperture, the centring lines being attached at one of their ends to respective first attachment points on the inner surface of the envelope and at their respective other ends to second attachment points at or near the edge of the parachute panel, the first and second attachment points for each centring line being positioned substantially diametrically opposite each other relative to the aperture.

In a particular embodiment of the above aspect, wherein the aperture and the parachute panel are circular, the respective first attachment points on the inner surface of the envelope are positioned adjacent the aperture, at a distance from the centre of the aperture less than or equal to the radius of the parachute panel, in a region overlapped by the parachute panel when in its closed position. Alternatively, the respective first attachment points on the inner surface of the envelope may be positioned at a distance from the centre of the aperture which is greater than the radius of the parachute panel.

The present invention also provides such venting means per se, suitable for incorporating in or retrofitting to a thermal aircraft, such as a hot air balloon.

### BRIEF DESCRIPTION OF THE DRAWINGS

FIG. 1 is a schematic cross-sectional view of a hot air balloon including a parachute panel according to a first embodiment of the invention;

FIG. 2 is a schematic cross-sectional view of the hot air balloon of FIG. 1, showing the parachute panel in the deflation position;

FIG. 3 is a cross-sectional view of an upper portion of a hot air balloon incorporating a venting arrangement according to a second embodiment of the present invention, showing the parachute panel in the closed position;

FIG. 4 is a view of the vent of FIG. 3 in the open or deflating position;

FIG. 5 is a view from above of an inflated envelope, showing the parachute panel in the closed position and alternative arrangements for the limiting cords.

### DETAILED DESCRIPTION OF THE PREFERRED EMBODIMENTS

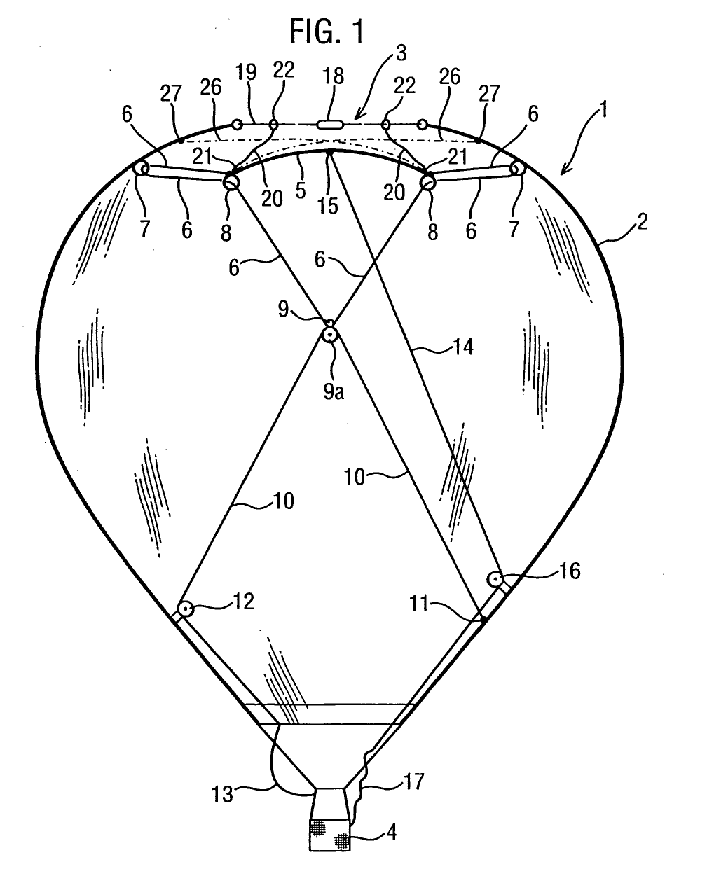

Referring to FIG. 1, there is shown a hot air balloon 1 comprising a hot-air-inflatable envelope or aerostat 2 embodying a plurality of gored sections, and having an opening or aperture 3 at the upper end and a basket or gondola 4 at the lower end where the balloon operator or pilot rides. The aperture 3 is closable by means of a venting valve comprising an operculum or parachute panel 5 of parachute form located adjacent the aperture. The parachute panel is larger than the aperture, to provide a sealing area surrounding the aperture where the parachute panel 5 overlaps and seals with the interior surface of the balloon envelope 2. The parachute panel is preferably constructed from a plurality of slender substantially triangular gores joined with their apices together.

Control lines 6 are attached to the outer periphery of the parachute panel at spaced locations, each control line extending to pass through a first ring or pulley 7 fixed on the inner surface of the envelope 2, and then returning to pass through a second ring or pulley 8 attached at or near the periphery of the parachute panel 5. A plurality of such control lines 6 and rings or pulleys 7 (e.g. from 12 to 24, depending on the size of the balloon envelope and the number of segments or gores of which it is comprised) are spaced circumferentially about the parachute panel 5. After passing through their respective second rings 8, the control lines 6 converge downwardly to join together at a clew 9, to which is attached a pulley 9a.

A parachute activation cord 10 is tethered at one end to the inner wall or a rib of the envelope towards the lower and thereof, as indicated at 11. The activation cord 10 then passes through the pulley 9a, and extends downwardly via a pulley 12 fixed on the inner surface of the envelope 2 to the operator or balloon pilot in the basket 4. The lower end 13 of the activation cord can be attached to a suitable load frame at a point convenient for use by the pilot.

By pulling on activation cord 10, control lines 6 are tensioned to extend the parachute panel 5 to its full diameter, or to its full surface area. By pulling even harder on the activation cord 10, the parachute panel 5 is pulled downwardly about its periphery away from the aperture, to provide venting of the hot air from within the balloon envelope to the outside ambient atmosphere in a manner similar to the operation of a conventional parachute valve. Use of the venting valve in this way is ideal for manoeuvring of the balloon. Upon releasing the pull pressure on the control lines 6 by releasing activation cord 10, the parachute panel 5 is forced upwards under the influence of the air pressure within the envelope, to reseal the balloon aperture.

A deflation line 14, forming the second control means of the aircraft, extends from a fixing point 15 at the centre of the parachute panel 5 to a pulley 16 fixed on the inner surface of the envelope 2, and thence to the balloon pilot in the basket 4. As for the activation cord 10, the lower end 17 of the deflation line 14 may be attached to the basket or to a load frame at a convenient location for the pilot. To avoid inadvertent operation of the deflation line 14, the lower ends 13 and 17 of the activation cord 10 and the deflation line may be colour coded or otherwise distinguishable.

The aperture 3 in the envelope 2 provides open communication between the interior of the balloon and the outside atmosphere, except for a central crown ring 18 and a plurality of spaced apart radially extending tapes 19. The crown ring 18 and load tapes 19 are referred to as a spider. The spider serves to retain the parachute panel in place in the balloon aperture, and also serves to contribute to the integral strength and stability of the balloon envelope.

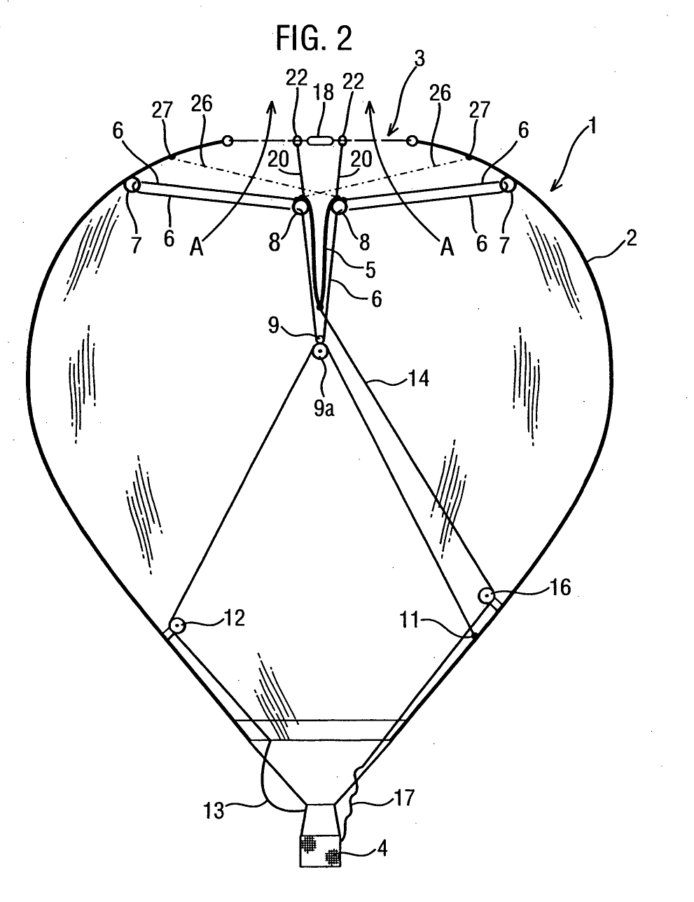

As can be seen in FIGS. 1 and 2, limiting cords 20 are attached at one of their ends 21 at the periphery of the parachute panel and at their other ends to rings 22 which loosely encircle respective ones of the load tapes 19, and act as sliding attachments of the limiting cords 20 to the load tapes 19. The rings 22 may be substituted by pulleys or any other sliding connector attaching the limiting cord 20 to the load tape 19. The lengths of the limiting cords 20 may be substantially equal to the radial overlap between the parachute panel 5 and the envelope 2 surrounding the aperture 3, so that the rings 22 abut the edge of the aperture and the limiting cords 20 extend radially across the sealing area when the parachute panel is in the closed position. In this position, the limiting cords assist the control lines 6 in centring the parachute panel 5 beneath the aperture 3.

Alternatively, the lengths of the limiting cords 20 may be greater than the radial overlap between the parachute panel 5 and the envelope 2 surrounding the aperture 3, so that when the parachute panel is in the closed position the rings 22 may be spaced from the edge of the aperture and the limiting cords 20 extend loosely across the sealing area. Centring of the parachute panel in the closed position is, in this alternative embodiment, achieved solely by the symmetry of the control lines 6.

In operation, if the pilot wishes to descend or to simply vent the balloon the pilot pulls downwardly on the activation cord (13, 10, in FIG. 1). For venting of the balloon, a light pull on the cord is transferred to the control lines 6 whereby the outer perimeter of the parachute panel 5 is pulled away from the aperture 3 to allow venting of hot air from the balloon to the ambient atmosphere through the aperture 3. The upwardly directed force of the hot air within the balloon envelope maintains the central part of the parachute panel 5 hard up against the crown ring 18 and the tapes 19 of the spider in the aperture 3. When the pilot releases or eases the downward pull on the activation cord, the downward pulling force on the shroud lines 6 is also eased, and the outer perimeter of the parachute panel 5 is forced upwards by the internal pressure within the balloon such that the parachute seats against the edges of and seals the aperture 3 of the balloon.

When the pilot wants the balloon to deflate on landing, this is achieved by fully opening the parachute valve for rapid deflation of the envelope 2, as shown in FIG. 2, by means of a hard pull on the deflation line 17, 14. This draws the centre of the parachute panel downwards, the pressure of the air within the balloon forming the parachute panel into a conical fluted shape to unseat the parachute panel 5 completely from the aperture 3. As the periphery of the parachute is drawn radially inwards, the limiting cords 20 draw the rings 22 radially inwardly along their load tapes 19 to positions adjacent the crown ring 18. The limiting cords 20 then, in the fully open position of the parachute panel 5, suspend the panel 5 below the aperture 3 at a distance equal to the length of the limiting cords 20, as is seen in FIG. 2. Hot air rapidly exits the envelope 2 via aperture 3, as indicated by arrows A in FIG. 2.

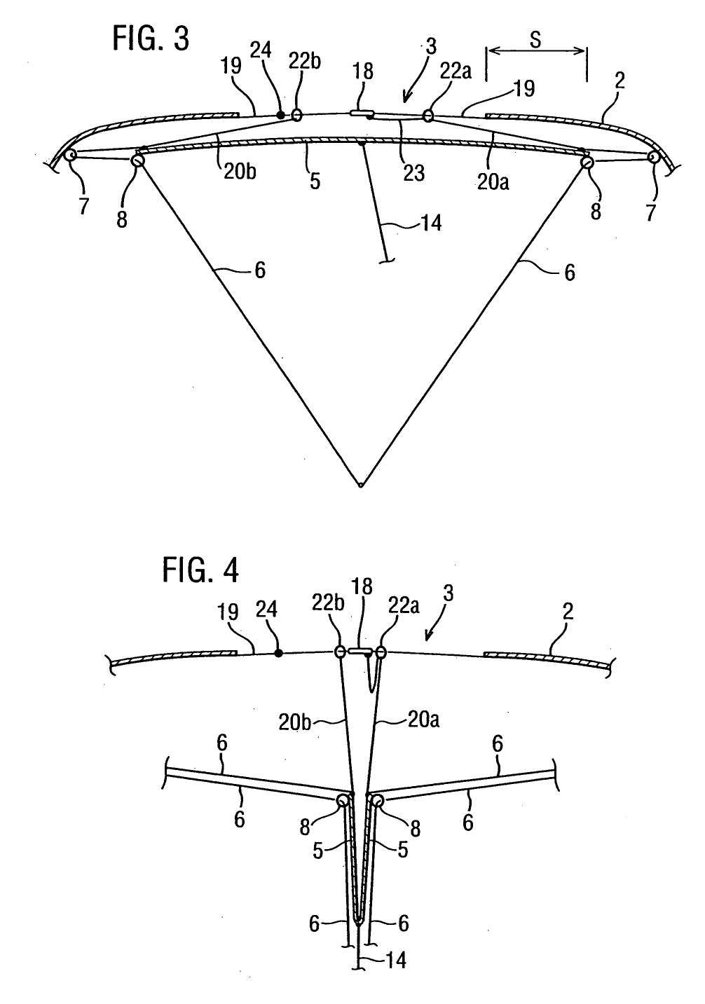

Referring now to FIGS. 3 and 4, there is shown a cross-sectional view of an upper portion of a hot air balloon incorporating a second embodiment of the venting arrangement of the present invention. FIG. 3 shows the venting arrangement in the closed position, whereas in FIG. 4 the vent is shown fully open. As previously, the hot air balloon 1 comprises a hot air inflatable envelope or aerostat 2 having an opening or aperture 3 at the upper end of the envelope. A plurality of load tapes 19 are affixed at spaced locations about the periphery of the aperture 3, and extending radially inwardly to join a central crown ring 18.

Limiting cord 20a, seen on the right-hand side of FIG. 3, has a length greater than the overlap S between the parachute panel 5 and the envelope 2 in the closed position. The ring or pulley 22a attached to limiting cord 20a is attached to the crown ring 18 by a centring cord 23, which prevents the ring 22a from moving away from the crown ring by more than the length of centring cord 23. By arranging for the combined lengths of each centring cord 23 and its respective limiting cord 20a to be equal to the radius of the parachute panel (in a circular balloon), then the parachute panel 5 may be held centrally beneath the aperture 3 when in the closed position by the stretched limiting cords 20a and centring cords 23. When in the deflation position, the rings 22 are positioned adjacent the crown ring 18 and the centring cords 23 are slack, and the parachute panel 5 is suspended below the aperture by a distance equal to the length of the limiting cords 20a, so that the parachute panel may be held clear of the aperture 3 even if the overlap distance S is small.

Limiting cord 20b, seen on the left-hand side of FIG. 3, also has a length greater than the overlap S between the parachute panel 5 and the envelope 2 in the closed position. The ring or pulley 22b attached to limiting cord 20b is prevented from moving away from the crown ring by more than a predetermined distance by a limit stop 24 fixed to the load tape 19 on which the ring 22b slides. By placing the limit stop 24 at a distance from the crown ring 18 such that the length of the limiting cord 20b plus the spacing between the limit stop 24 and the crown ring 18 is equal to the radius of the parachute panel (in a circular balloon), then the parachute panel 5 may be held centrally beneath the aperture 3 when in the closed position by the limiting cords 20b, with their rings 22b abutting the limit stops 24. As with the embodiment including limit cords 23, when the parachute panel 5 is in the deflation position, the rings 22b are positioned adjacent the crown ring 18 and the parachute panel 5 is suspended below the aperture 3 by a distance equal to the length of the limiting cords 20b, so that the parachute panel may be held clear of the aperture 3 even if the overlap distance S is small.

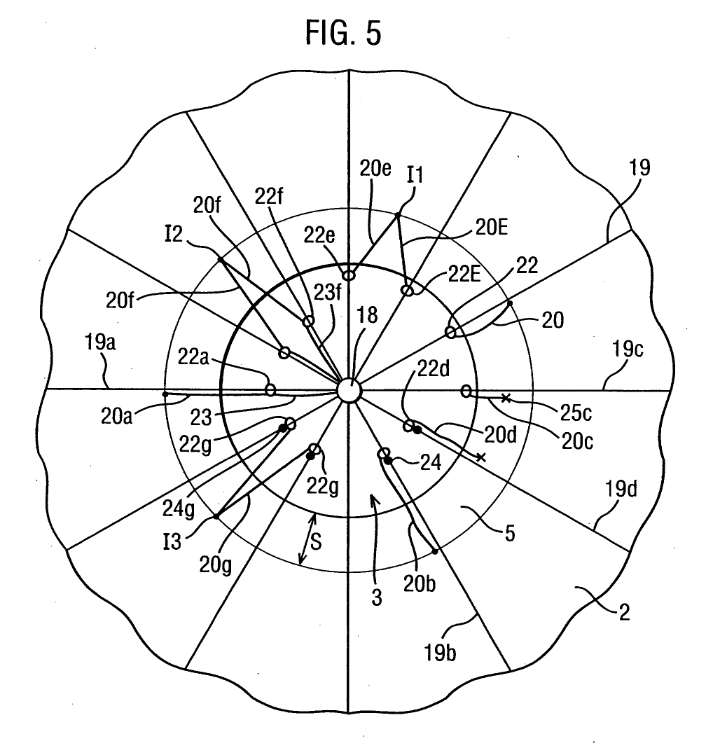

Various different arrangements of the limiting cords 20 are shown in FIG. 5, which is a partial view from above of a circular hot air balloon. The balloon comprises an envelope 2 formed from a plurality of gores, with load tapes 19 running along the joints between gores to meet at a crown ring 18. An aperture 3 is formed at the top of the balloon, and is openably sealed by a parachute panel 5 having a diameter larger than that of the aperture. A radial overlap region indicated by S represents a sealing area surrounding the aperture 3 and engaged by the parachute panel, which is seen in its closed position. In the arrangements shown, the lengths of the limiting lines are substantially less than the diameter of the parachute panel, resulting in the panel being suspended at a position less than one parachute radius below the aperture when in the deflation position, resulting in a reliably resettable panel which does not excessively impede the egress of hot air during deflation.

At the upper right of the Figure, load tape 19 has a limiting cord 20 attached to it by a ring or pulley 22, the length of the limiting cord being equal to the radial overlap S. This is the arrangement shown in FIGS. 1 and 2.

To the left in the Figure, the load tape 19a has a limiting cord 20a attached to it by a ring or pulley 22a, the length of the limiting cord 20a being greater than the radial overlap S, and ring or pulley 22a of the limiting cord 22a being attached to the crown ring 18 by a limit cord 23. This is the arrangement shown in FIGS. 3 and 4, right hand side.

To the lower right in FIG. 5, the load tape 19b has a limiting cord 20b attached to it by a ring or pulley 22b, the length of the limiting cord 20b being greater than the radial overlap S, and ring or pulley 22b of the limiting cord 20b being prevented by a stop 24 from moving further away from the crown ring 18. This is the arrangement shown in FIGS. 3 and 4, left-hand side.

To the right in the Figure, the load tape 19c has a limiting cord 20c attached to it by a ring or pulley 22c, the length of the limiting cord 20c being less than the radial overlap S, and the limiting cord 20c being attached to the parachute panel 5 at a point 25c spaced from the periphery of the panel 5. It will be appreciated that with short limiting cords 20c, the parachute panel will be suspended close to the aperture 3 when in the deflation position. Such an arrangement may however be satisfactory if the overlap S is large, or if point 25c is close to the edge of the panel 5.

To the lower right in FIG. 5, the load tape 19d has a limiting cord 20d attached to it by a ring or pulley 22d, the limiting cord 20d being attached to the parachute panel 5 at a point 25c spaced from the periphery of the panel 5. The ring or pulley 22d of the limiting cord 20d is prevented by a stop 24 from moving further away from the crown ring 18.

As an alternative to the arrangement shown in FIGS. 1 and 2, a pair of limiting cords 20 may be attached at or near the periphery of the panel 5 at attachment points such as I1, I2 and I3 each positioned between two load tapes, with each limiting cord attaching to the spider by, for example, a ring or pulley running on a respective one of the load tapes. From point I1 on the periphery of the panel 5 in FIG. 5, limiting cords 20e extend to rings 22e on adjacent load tapes in an arrangement which operates similarly to the embodiment shown in FIGS. 1 and 2.

From point I2 on the periphery of the panel 5 in FIG. 5, limiting cords 20f extend to rings 22f on adjacent load tapes, the rings 22f being attached to the crown ring by limit cords 23f tapes in an arrangement which operates similarly to the embodiment shown in FIGS. 3 and 4, right hand side.

From point I3 on the periphery of the panel 5 in FIG. 5, limiting cords 20g extend to rings 22g on adjacent load tapes, the rings 22g of the limiting cords 20g being each prevented by a stop 24g from moving further away from the crown ring 18. This is the arrangement shown in FIGS. 3 and 4, left-hand side.

Limiting cords are preferably provided on the parachute panel at three or more locations around the panel. Preferably four or more limiting cords are provided. Most preferably the limiting cords are provided at positions spaced equally round the circumference of the parachute panel. The limiting cords may be attached to the parachute panel at its periphery, or at positions spaced from the periphery of the panel. Two limiting cords may be attached to the panel at the same position, either at the periphery of the panel or spaced therefrom.

A further alternative embodiment of the invention, dual-purpose limiting and centring lines are provided to extend from the edge of the parachute panel 5 diametrically across the aperture 3, the lines then being attached to the inner surface of the envelope 2 at attachment points either at the edge of the aperture 3, or within or radially outside the sealing region surrounding the aperture. This alternative limiting/centring line arrangement is shown in FIGS. 1 and 2 with the limiting/centring lines 26 seen in chain line, and their attachment points on the envelope 2 being referenced as 27. A plurality of such limiting/centring lines 26, preferably at least three, are provided instead of the centring lines 20 to centre the panel 5 relative to the aperture 3 in the closed position, and to suspend the panel 5 beneath the aperture 3 in the deflation position. The attachment point 27 for each limiting/centring line is preferably positioned, relative to the aperture, substantially diametrically opposite its attachment point to the parachute panel 5.

The attachment points 27 on the inner surface of the envelope 2 may be positioned at the edge of the aperture 3, or at a distance from the centre of the aperture less than or equal to the radius of the parachute panel 5, in a region overlapped by the parachute panel 5 when in its closed position. Alternatively, the attachment points 27 on the inner surface of the envelope 2 may be positioned at a distance from the centre of the aperture greater than the radius of the parachute panel.

When the parachute panel 5 is in the closed position, the limiting/centring lines 26 extend diametrically across the upper surface of the parachute panel 5 to hold the panel centred relative to the aperture 3. Venting of the parachute in flight is unhindered, since the limiting/centring lines 26 simply curve down as the edge of the parachute is drawn down for venting.

When the parachute panel 5 is drawn into the deflation position, as shown in FIG. 2, the limiting/centring lines 26 extend downwardly and inwardly from their attachment points 27 on the envelope 3 to form an inverted cone, suspending the parachute panel at the apex of the inverted cone. The parachute panel is held below the aperture during deflation by a distance less than the length of the limiting/centring lines 26.

With the valving arrangement of the present invention in the deflation position, the balloon envelope empties of hot air in about 60% of the time it takes for a parachute vent of the same size. The other main advantage is that after the vent has been actuated for deflation, should the pilot change his mind (e.g. because of adverse landing conditions), the vent can be reset halfway through the landing, enabling the balloon to continue in flight. Another advantage is that when the balloon is being inflated before a flight, the vent of the present invention is easier to reset than a standard parachute vent. Preferably, the vent panel or parachute panel 5 is fitted to the balloon aperture and held temporarily in the required orientation or position during inflation by means of a plurality of ‘Velcro’ (Trade Mark) tabs or similar burr-type fastening material.

Although exemplary embodiments of the present invention have been shown and described, it will be appreciated by those having ordinary skill in the art that a number of changes, modifications or alterations to the invention herein may be made, none of which depart from the spirit of the present invention. All such changes, modifications and alterations should therefore be seen as being within the scope of the present invention.

It should be appreciated that the present invention provides a substantial advance in the generation and control of thermal aircraft, such as hot air balloons, providing all of the herein described advantages without incurring any relative disadvantage.

1. A thermal aircraft having an outer envelope for containing a quantity of hot air and supporting a load-carrying basket, the envelope having an aperture formed therein at or near its upper end to permit outflow of air from the interior of the envelope, a spider comprising a plurality of load tapes extending radially across said aperture, removable venting means comprising a parachute panel adapted to close said aperture under pressure of air inside the envelope, first control means operable to move the periphery of the parachute panel away from the aperture to permit controlled venting in flight, and second control means operable to draw the parachute panel radially inwardly and downwardly away from the aperture for rapid deflation of the envelope, and wherein the venting means further includes a plurality of limiting lines attached at one of their ends to the parachute panel and at their other ends to respective ones of the load tapes of the spider for limiting the downward movement of the parachute panel away from the aperture.

2. A thermal aircraft according to claim 1, wherein the limiting lines are attached at their said one ends to the parachute panel at or near its periphery.

3. A thermal aircraft according to claim 1, wherein said first control means is operable in a first mode to move the periphery of the parachute panel away from the aperture to permit controlled venting in flight, and in a second mode to extend the parachute panel laterally or radially to its maximum surface area to removably cover and seal said aperture.

4. A hot air balloon having an outer envelope for containing a quantity of hot air and supporting a load-carrying basket, the envelope having an aperture formed therein at or near its upper end to permit outflow of air from the interior of the envelope, a spider comprising a plurality of load tapes extending radially across said aperture, removable venting means comprising a parachute panel having a diameter larger than that of the aperture, and adapted to close said aperture under pressure of air inside the envelope, first control means operable to move the periphery of the parachute panel away from the aperture to permit controlled venting in flight, and second control means operable to draw the parachute panel radially inwardly and downwardly away from the aperture for rapid deflation of the envelope, and wherein the venting means further includes a plurality of limiting lines attached at one of their ends to the parachute panel and at their other ends to respective ones of the load tapes of the spider for limiting the downward movement of the parachute panel away from the aperture.

5. A hot air balloon according to claim 4, wherein the limiting lines are attached at their said one ends to the parachute panel at or near its periphery.

6. A hot air balloon according to claim 4, wherein the lengths of said limiting lines are substantially less than the radius of the parachute panel.

7. A hot air balloon according to claim 6, wherein said limiting lines are slidingly attached at their said other ends to said load tapes, ropes or cords of said spider.

8. A hot air balloon according to claim 7, wherein said limiting lines are attached at their said other ends to respective rings or pulleys encircling respective ones of said load tapes of said spider

9. A hot air balloon according to claim 4, wherein said first control means is operable in a first mode to move the periphery of the parachute panel away from the aperture to permit controlled venting in flight, and in a second mode to extend the parachute panel laterally or radially to its maximum surface area to removably cover and seal said aperture.

10. A hot air balloon according to claim 9, wherein the lengths of said limiting lines are substantially less than the radius of the parachute panel.

11. A hot air balloon according to claim 10, wherein said limiting lines are slidingly attached at their said other ends to said load tapes of said spider.

12. A hot air balloon according to claim 11, wherein said limiting lines are attached at their said other ends to respective rings or pulleys encircling respective ones of said load tapes of said spider

13. A hot air balloon according to claim 4, wherein two of said limiting lines are attached at their said one ends to the parachute panel at the same position.

14. A hot air balloon according to claim 4, wherein said limiting lines are attached at their said one ends to the parachute panel at positions spaced from the periphery of the parachute panel.

15. A hot air balloon according to claim 14, wherein two of said limiting lines are attached at their said one ends to the parachute panel at the same position.

16. Venting means for a thermal aircraft, said thermal aircraft having an outer envelope for containing a quantity of hot air and supporting a load-carrying basket, the envelope having an aperture formed therein at or near its upper end to permit outflow of air from the interior of the envelope, a spider comprising a plurality of load tapes extending radially across said aperture, and said venting means comprising a parachute panel having a diameter larger than that of the aperture, and adapted to close said aperture under pressure of air inside the envelope, first control means operable to move the periphery of the parachute panel away from the aperture to permit controlled venting in flight, and second control means operable to draw the parachute panel radially inwardly and downwardly away from the aperture for rapid deflation of the envelope, and wherein the venting means further includes a plurality of limiting lines attached at one of their ends to the parachute panel and at their other ends to respective ones of the load tapes of the spider for limiting the downward movement of the parachute panel away from the aperture.

17. Venting means according to claim 16, wherein said first control means is operable in a first mode to move the periphery of the parachute panel away from the aperture to permit controlled venting in flight, and in a second mode to extend the parachute panel laterally or radially to its maximum surface area to removably cover and seal said aperture.

18. Venting means according to claim 16, wherein the lengths of said limiting lines are substantially less than the radius of the parachute.

19. Venting means according to claim 16, wherein said limiting lines are slidingly attached at their said other ends to said load tapes of said spider.

20. Venting means according to claim 19, wherein said limiting lines are attached at their said other ends to respective rings or pulleys encircling respective ones of said load tapes, ropes or cords of said spider

21. Venting means according to claim 16, wherein said limiting lines are attached to said parachute panel at their said one ends at or near the periphery of the parachute panel.

22. Venting means according to claim 16, wherein two of said limiting lines are attached at their said one ends to the parachute panel at the same position.

23. Venting means according to claim 16, wherein said limiting lines are attached at their said one ends to the parachute panel at positions spaced from the periphery of the parachute panel.

24. Venting means according to claim 23, wherein two of said limiting lines are attached at their said one ends to the parachute panel at the same position.

25. A thermal aircraft, such as a hot air balloon having an outer envelope for containing a quantity of hot air and supporting a load-carrying basket, the envelope having an aperture formed therein at or near its upper end to permit outflow of air from the interior of the envelope, a spider comprising a plurality of load tapes extending radially across said aperture, removable venting means comprising a parachute panel adapted to close said aperture under pressure of air inside the envelope, first control means operable to move the periphery of the parachute panel away from the aperture to permit controlled venting in flight, and second control means operable to draw the parachute panel radially inwardly and downwardly away from the aperture for rapid deflation of the envelope, and wherein the venting means further includes limiting lines for limiting the downward movement of the parachute panel away from the aperture, the limiting lines being attached at one of their ends to respective first attachment points on the inner surface of the envelope and at their respective other ends to second attachment points at or near the edge of the parachute panel, the limiting lines extending across the aperture when the parachute panel closes the aperture.

26. A thermal aircraft according to claim 24, wherein the first and second attachment points for each limiting line are positioned substantially diametrically opposite each other relative to the aperture.

27. A thermal aircraft according to claim 24, wherein the aperture and the parachute panel are circular, and wherein the respective first attachment points on the inner surface of the envelope are positioned at the edge of the aperture.

28. A thermal aircraft according to claim 24, wherein the aperture and the parachute panel are circular, and wherein the respective first attachment points on the inner surface of the envelope are positioned adjacent the aperture, at a distance from the centre of the aperture less than or equal to the radius of the parachute panel, in a region overlapped by the parachute panel when in its closed position.

29. A thermal aircraft according to claim 24, wherein the aperture and the parachute panel are circular, and wherein the respective first attachment points on the inner surface of the envelope are positioned at a distance from the centre of the aperture greater than the radius of the parachute panel.
